(19) United States
(12) Patent Application Publication
(10) Pub. No.: US 2005/0050313 A1
(43) Pub. Date: Mar. 3, 2005

(54) METHOD OF TURNING ON A COMPUTER

(76) Inventors: Yi-Chang Chen, Taipei Hsien (TW); Chih-Hsuan Wu, Taipei Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,658

(22) Filed: Oct. 16, 2003

(30) Foreign Application Priority Data
Aug. 28, 2003 (TW) 092123826

(51) Int. Cl. G06F 15/177; G06F 9/445

(52) U.S. Cl. 713/2

(57) ABSTRACT

A method of turning on a computer includes providing the computer with a hard disk drive and a switch, and storing a first master boot record (MBR) in a first region of the hard disk drive, the first MBR corresponding to a set of operation systems comprising at least an operation system. The method also includes storing a second MBR in a second region of the hard disk drive, the second MBR corresponding to a set of program codes comprising at least a program code, and powering on the computer. A status of the switch is then detected, and a program code of the set of program codes is executed if the switch is on a predetermined status, or an operation system of the set of operation systems is executed if the switch is not on the predetermined status.

### BACKGROUND OF INVENTION

1. Field of the Invention

The present invention relates to a computer, and more particularly, to a method of turning on the computer.

2. Description of the Prior Art

After being loaded by an operating system boot program into a random access memory (RAM) of a computer, an operating system (OS) stored in the computer can manage application programs of the computer. A computer can contain two or more than two operating systems, such as DOS, OS/2, Windows, and Linux, to facilitate working in a variety of environments.

Please refer to FIG. 1, which is a flow chart of a method 100 for loading the OS into the RAM of the computer according to the prior art. The method 100 comprises following steps:

Step 102: Start; (The computer further comprises a floppy disk drive (FDD), a hard disk drive stored with the OS and a master boot record (MBR) corresponding to the OS, a read only memory (ROM) stored with a basic input/output system (BIOS), and a processor for executing the BIOS and the OS. The MBR comprises the operating system boot program.)

Step 104: Power on the computer; (The processor executes the BIOS immediately.)

Step 106: Execute a power on self test (POST) with the BIOS; if every hardware of the computer functions well, then go to step 108, else go to step 198; (The POST is to test whether the hardware, such as the RAM, the hard disk drive and a keyboard, of the computer functions well.)

Step 108: Search the FDD of the computer for the operating system boot program; if the FDD is not installed with any floppy disk or the FDD is indeed installed with a floppy disk but the floppy disk is not a boot floppy disk comprising the operating system boot program, go to step 110, else go to step 112;

Step 110: Search the hard disk drive for the operating system boot program;

Step 112: Save the MBR into the RAM (usually into a memory space of an address of 07c00h)

Step 114: Load an initial system file from the OS into the RAM with the MBR; (DOS has an initial system file of IO.SYS.)

Step 116: Load remaining files from the OS into the RAM with the initial system file; (The remaining files includes, for example, MSDOS.SYS, CONFIG.SYS, and AUTOEXEC.BAT (for DOS) or WIN.INI (for Windows) etc.)

Step 198: End.

(To have come this far, either some hardware of the computer are abnormally functioning, or the computer can have application programs with the OS through the use of an application program interface (API).)

In general, the MBR is stored in the hard disk drive at cylinder 0, head 0, sector 1, a so-called track 0. The MBR is 512 bytes in capacity (from 000 to 1FF) and is divided into two parts: one for storing a master boot program (MBP), and the other for a partition table. The MBP and partition table as well are crucial information to boot the computer. If the memory space of track 0 of the hard disk drive is destroyed, the computer cannot do anything but malfunction. Strictly speaking, the computer cannot be booted again.

Since most computers store the MBR in the hard disk drive at track 0, a boot strap sector virus, such as a MONKEY virus and a Michelangelo virus, is capable of taking the advantage of this feature to substitute a predetermined program code for the MBR and affecting the computer. If the boot strap sector virus substitutes the predetermined program code for the MBP only, the MBR can still be recovered by the use of a partition program such as FDISK for Windows. However, if what the virus affects is the partition table, since the partition table of the computer is different from a partition table of any other computers, the hard disk drive of the computer is therefore “dead” forever.

### SUMMARY OF INVENTION

It is therefore a primary objective of the claimed invention to provide a method of turning on a computer to solve the drawbacks of the prior art.

According to the claimed invention, the method of turning on a computer includes the following steps: (a) providing the computer with a hard disk drive and a switch, (b) storing a first master boot record (MBR) in a first region of the hard disk drive, the first MBR corresponding to a set of operation systems comprising at least an operation system, (c) storing a second MBR in a second region of the hard disk drive, the second MBR corresponding to a set of program codes comprising at least a program code, (d) powering on the computer, and (e) detecting a status of the switch and executing a program code of the set of program codes if the switch is on a predetermined status, or executing an operation system of the set of operation systems if the switch is not on the predetermined status.

According to the embodiment, the program codes include an operating system or a drive program for driving a CD drive.

It is an advantage of the claimed invention that a method of turning on a computer by storing two master boot records into a hard disk drive at two distinct memory spaces can prevent the hard disk drive from being severely affected by boot strap sector viruses. In addition, the method can enable the drive program to drive a CD drive by the control of the switch.

These and other objectives of the claimed invention will no doubt become obvious to those of ordinary skill in the art after reading the following detailed description of the embodiment that is illustrated in the various figures and drawings.

### BRIEF DESCRIPTION OF DRAWINGS

FIG. 1 is a flow chart of a method of loading an operating system into a RAM of a computer according to the prior art.

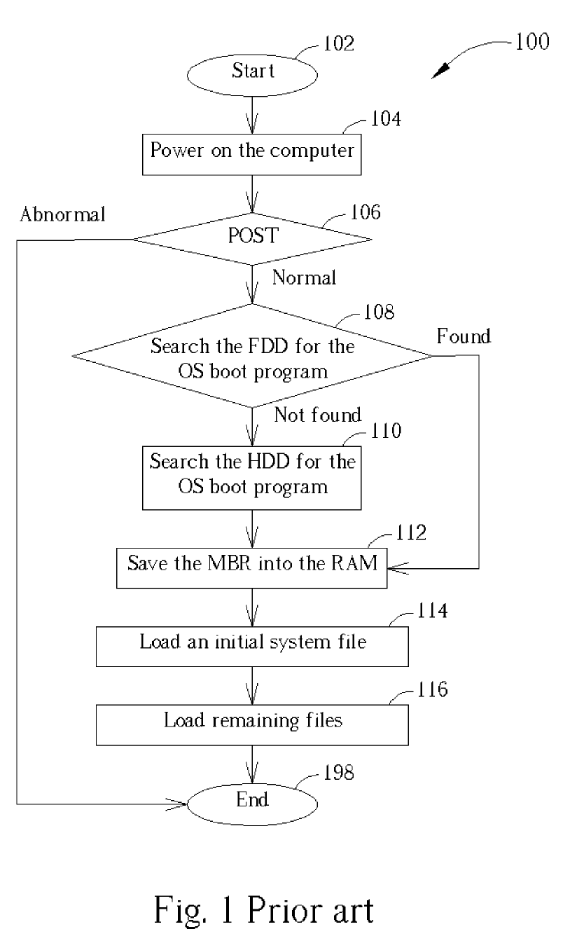

FIG. 2 is a function block diagram of a computer of the embodiment according to the present invention.

FIG. 3 is a flow chart of a method of turning on the computer shown in FIG. 2 according to the present invention.

### DETAILED DESCRIPTION

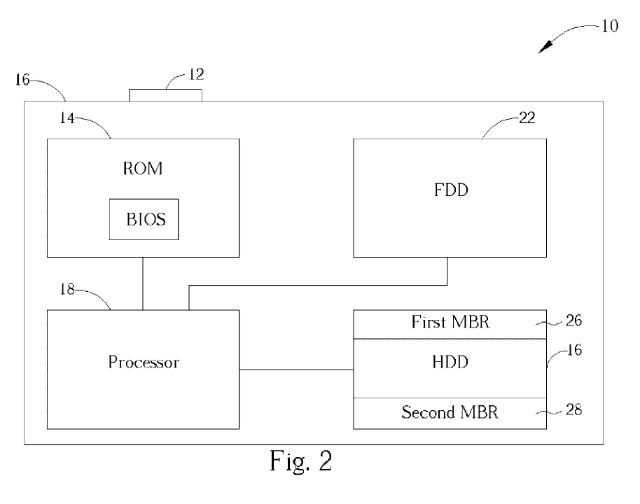

Please refer to FIG. 2, which is a function block diagram of a computer 10 of the embodiment according to the present invention. The computer 10 comprises a housing 24, a switch 12 installed on a surface of the housing 24, a floppy disk drive 22, a first memory device 14 stored with a BIOS, a second memory device 16 comprising a first region 26 stored with a first MBR and a second region 28 stored with a second MBR, and a processor 18 electrically connected to the switch 12, the floppy disk drive 22, the first memory device 14 and the second memory device 16.

In general, an MBR comprises four entries respectively indicating four distinct partitions, only one of the entries being labeled bootable (can be labeled with FDISK). The MBR is therefore capable of determining a bootable sector according to the bootable entry with an MBP of the MBR and of booting an OS stored in the bootable sector. In the embodiment of the present invention, the first MBR corresponds to a set of operating systems comprising at least an operation system, such as DOS, OS/2, Windows, and Linux, and the second MBR corresponds to a set of program codes comprising at least a program code like an OS or a drive program code to drive a CD drive. The processor 18 is for executing the BIOS and for executing either an OS of the set of operating systems or a program code of the set of program codes by determining a status of the switch 12. The first memory device 14 can be a ROM 14, and the second memory device 16 can be a hard disk drive 16. The first region 26 occupies the first 512 bytes of the hard disk drive 16, and the second region 28 is located thereafter. In general, the hard disk drive further comprises a first data region located after the second region 28 and a second data region located between the first region 26 and the second region 28. The processor 18 can selectively manage data stored either in the first data region or in the second data region to any extent by determining whether an OS that the processor 18 has executed corresponds to the second MBR or to the first MBR.

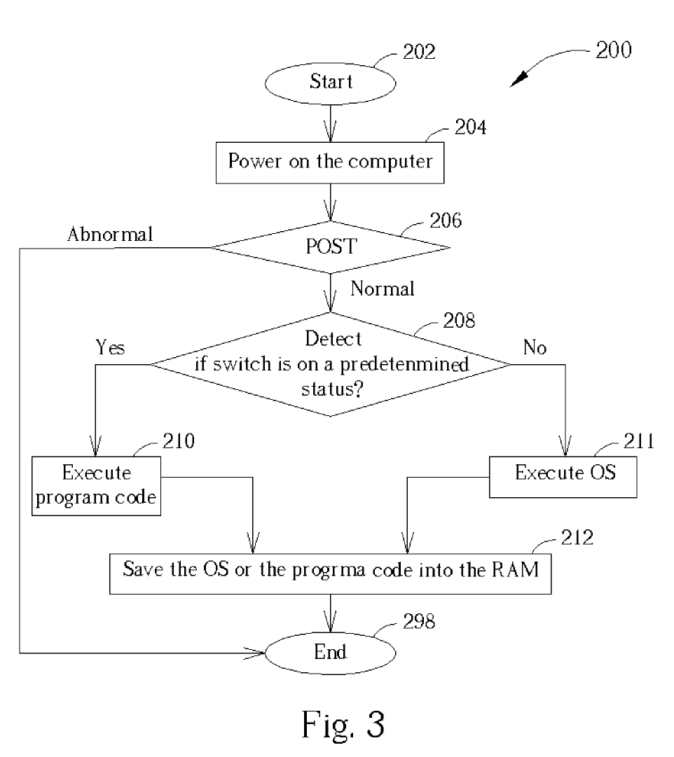

Please refer to FIG. 3, which is a flow chart of a method 200 of turning on the computer 10 of the embodiment according to the present invention. The method 200 comprises following steps:

Step 202: Start;

Step 204: Power on the computer 10; (The processor 18 executes the BIOS immediately.)

Step 206: Executing a POST; if every hardware of the computer 10 functions well, then go to step 208, else go to step 298;

Step 208: Detecting a status of the switch 12; if the switch is on a predetermined status, then go to step 210, else go to step 211; (The BIOS comprises a SET Features Enable Address Offset Mode instruction for updating a pointer to a predetermined position and updates the pointer to the predetermined position when the switch 12 is on the predetermined status.)

Step 210: Execute a program code of the set of program codes; go to step 212;

Step 211: Execute an OS of the set of operating systems; go to step 212;

Step 212: Save the program code of the set of program codes or the OS of the set of operating systems into a RAM of the computer 10; and (The program code and the OS are usually stored into a memory space of an address of 07c00h.)

Step 298: End.

(To have come this far, some hardware of the computer 10 are abnormally functioning from step 206, the computer 10 can have application programs with the OS through the use of an application program interface (API), or the computer 10 can drive a CD drive with a drive program.)

In the embodiment, the switch 12 is installed on the surface of the housing 24. Accordingly, the program code the second MBR corresponds can be a drive program for driving an audio or video player of the computer 10. Alternatively, the switch 12 can be installed inside the housing 24 and the program code the second MBR corresponds can be a maintenance drive program only for a maintenance worker. Therefore, the maintenance worker can open the housing 24 and control the switch to execute the maintenance and to maintain the computer 10.

In contrast to the prior art, the present invention can provide a method of turning on a computer by storing a first MBR into a hard disk drive at track 0, a place most hard disk drives have their MBR store in, and a second MBR located after the first MBR. A boot strap sector virus will not find the second MBR and destroy the computer. In addition, the method comprises a step of installing a switch on or inside a housing of the computer. Therefore, the computer can selectively execute an OS the first MBR corresponds or an OS or a drive program the second MBR corresponds with a processor by determining a status of the switch.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

1. A method of turning on a computer, the method comprising:
providing the computer with a hard disk drive and a switch;
storing a first master boot record (MBR) in a first region of the hard disk drive, the first MBR corresponding to a set of operation systems comprising at least an operation system;
storing a second MBR in a second region of the hard disk drive, the second MBR corresponding to a set of program codes comprising at least a program code;
powering on the computer; and
detecting a status of the switch and executing a program code of the set of program codes if the switch is on a predetermined status, or executing an operation system of the set of operation systems if the switch is not on the predetermined status.

2. The method of claim 1 wherein the program code comprises an operation system.

3. The method of claim 1 wherein the program code comprises a drive program.

4. The method of claim 1 wherein the first region occupies first 512 bytes of the hard disk drive.

5. The method of claim 1 wherein the second region is located after the first region.

6. The method of claim 1 further comprising:
providing the computer with a housing.

7. The method of claim 6 further comprising:
installing the switch on a surface of the housing.

8. The method of claim 6 further comprising:
installing the switch on a region inside the housing.

9. A computer comprising:
a switch;
a first memory stored with a basic input/output system (BIOS);
a second memory comprising a first region stored with a first MBR corresponding to a set of operation systems comprising at least an operation system, and a second region stored with a second MBR corresponding to a set of program codes comprising at least a program code; and
a processor for executing the BIOS and selectively executing an operation system of the set of operation systems if the switch is on a predetermined status or a program code of the set of program codes if the switch is not on the predetermined status.

10. The computer of claim 9 wherein the first memory is a read only memory (ROM).

11. The computer of claim 9 wherein the second memory is a hard disk drive.

12. The computer of claim 11 wherein the first region occupies first 512 bytes of the hard disk drive.

13. The computer of claim 9 wherein the second region is located after the first region.

14. The computer of claim 9 wherein the program code comprises an operation system.

15. The computer of claim 9 wherein the program code comprises a drive program.

16. The computer of claim 9 further comprising a housing for the switch to be installed inside.

17. The computer of claim 9 furthering comprising a housing having a surface for the switch to be installed on.
